(19) United States
(12) Patent Application Publication
(10) Pub. No.: US 2020/0152237 A1
(43) Pub. Date: May 14, 2020

(54) System and Method of AI Powered Combined Video Production

(71) Applicants: Zuoliang Chen, San Francisco, CA (US); Anissa Chen, San Francisco, CA (US); Andy Chen, San Francisco, CA (US)

(72) Inventors: Zuoliang Chen, San Francisco, CA (US); Anissa Chen, San Francisco, CA (US); Andy Chen, San Francisco, CA (US)

(21) Appl. No.: 16/188,301

(22) Filed: Nov. 13, 2018

(51) Int. Cl. G11B 27/034; G11B 27/34; G10L 15/08

(52) U.S. Cl. CPC G11B 27/034; G10L 15/08; G11B 27/34

(57) ABSTRACT

The System and Method of AI-Powered Combined Video Production of the present invention is a digital platform used by both master clip Creators and scene clip creators. In a preferred embodiment, the platform comprises at least one master clip creating device, an APCV application, at least one scene clip creating device, a scene clip database, a scene clip uploading interface, an AI module, a scene clip searching & selecting module, and a network. The platform uses AI technology to detect the master clip attributes of a master clip, and then use the detected master clip attributes to search a scene clip database and select at least one scene clip its defined attributes match the detected master clip attributes, and then the APCV application will combine the master clip with the selected scene clip to create an APC video. The present invention makes it extremely easy for average people to create high quality tailor-made combined videos.

### RELATED APPLICATION

This application claims priority from U.S. Provisional Patent Application No. 62/647,820, filed on Mar. 25, 2018, entitled System and Method of AI-Powered Collaborative Short Video Production

### FIELD OF THE INVENTION

The present invention is related to a system and method, more specifically an AI-powered digital platform that enables average people to create high quality tailor-made combined videos easily.

### BACKGROUND

As the rapid development of smart phone and online social media, many people like to record short videos and share them to online social medias. Although it is extremely easy for people to record short videos with their smart phones nowadays, however, for average people who don't have the necessary skill, resources and time, it is still very difficult for them to produce high quality short videos that can meet their needs. In view of this, many apps such as Instagram, Snapchat etc. provide special filters or lenses to their users to produce more fancy or funny short videos. However, although such filters or lenses become very popular these days, they are merely special editing tools that help average people to make a short video look more attractive or funny, rather than content creating tools that help average people to create high quality short video contents easily.

Therefore, there is a strong need for a platform in which average people can easily create high quality tailor-made short videos, without any skills, without any special resources and without any limitations.

### DESCRIPTION OF THE PRIOR ART

The technology of combining several different video clips to form a single video has long been exists and is widely used by video editors. However, this technology is only a video editing feature instead of a content creating tool. To create a combined video, video editors are usually required to select all the video clips to be combined, this process is usually time consuming and costly. To make a high quality combined video, video editors are not only required to have good video editing skill, but are also required to have access to the resources of high quality video clips. Therefore, creating a high quality combined video is not an easy job for average people. Also, since the contents of all the video clips to be combined are known to the video editors, the finished combined video usually won't generate any surprise to the video editors.

As the rapid development of AI and smart phones, AI video making apps such as Magisto Video Maker become available to average people, these apps use AI technology to help their users to create combined videos easily. However, in these apps, AI technology is mostly used on video editing rather than selecting video clips from other sources, users still have to provide all the video clips from their own resources for making combined videos.

US Patent Application Pub No.: US 2009/0196570 A1 published on Aug. 6, 2009 disclose A system and related methods comprise an Internet-hosted application service for online storage, editing and sharing of digital video content, whereby a group of users collaborate to jointly create a video production. However, the collaboration in this prior art is only for each collaborators to add their video clips to a timeline to form a long video, each video content is independent, so it is more of sharing videos instead of creating a tailor-made new video for a particular collaborator.

US Patent Application Pub No.: US 2012/0311448 A1 published on Dec. 6, 2012 disclose a digital multimedia platform available to a plurality of collaborators of a video project through a networked computing system maps script information to a timeline, allowing contributions to be mapped to the timeline for inclusion in the project. This is more like providing a platform for professionals with different techniques collaborate to work on a project, rather than a platform for average person to create high quality combined videos easily.

### Advantages of Present Invention

A workable prototype app of the present invention has been successfully built and tested, most users like it because it enables them to create high quality, interesting and surprising tailor-made combined videos in seconds. The present invention has the following advantages:

1. Use AI technology in video clips selection and editing, thus makes it extremely easy for average people to create high quality tailor-made combined videos without any skills, resources and limitations.

2. Users can receive unexpected tailor-made combined videos that give them lots of surprise and excitements.

Further objects and advantages are to provide an AI-powered platform which enables average people to create high quality tailor-made combined videos easily. Further objects and advantages will become apparent from a consideration of the ensuing description and drawings.

### BRIEF DESCRIPTION OF DRAWINGS

FIG. 1 illustrates Platform 1 of the present invention.

FIG. 2 illustrates the main components of APCV application.

FIG. 3 illustrates the method of how a scene clip is created and stored for Platform 1.

FIG. 4 illustrates the method of how an APC Video is created.

FIG. 5 illustrates the main screens of APCV application for creating an APC Video.

FIG. 5-1 illustrates the camera screen of APCV application.

FIG. 5-2 illustrates the master clip screen of APCV application.

FIG. 5-3 illustrates the APC Video display screen of APCV application.

FIG. 6 illustrates Platform 2 of the present invention.

FIG. 7 illustrates the method of how a scene clip is created and stored for Platform 2.

FIG. 8 illustrates the main components of SC application.

FIG. 9 illustrates an APCV application which further having an APCV editing module.

FIG. 10 illustrates a SC Application which further having an SC editing module.

FIG. 11 illustrates how a long master clip is split into two shorter master clip A and master clip B.

FIG. 12 illustrates a typical APC video with two master clips and two scene clips.

### REFERENCE NUMERALS IN DRAWINGS

1 Platform 1
10 Master Clip Creator
11 MCC Device (Master Clip Creating Device)
110 APCV Application (APC Video Application)
111 Master Clip Creating Module
112 APC Video Creating Module
113 APCV Editing Module
12 Master Clip
121 Master clip 1
122 Master clip 2
12S Master clip splitting line
12A Split Master Clip A
12B Split Master Clip B
13 APC Video
131 APC Video Creating Button
2 Platform 2
20 Scene Clip Creator
21 SCC Device (Scene Clip Creating Device)
210 SC Application (Scene Clip Application)
211 Scene Clip Creating Module
212 Scene Clip Uploading Interface Module
22 Scene Clip
23 Scene Clip Database
24 Scene Clip Uploading Interface
25 Scene Clip Searching & Selecting Module
26 Selected Scene Clip
261 Selected Scene Clip 1
262 Selected Scene Clip 2
30 Network
40 AI Module

### DETAILED DESCRIPTION OF PREFERRED EMBODIMENT

The present invention is about a system and method, more specifically an AI-powered digital platform that enables its users to create high quality tailor-made combined videos easily. The platform uses AI technology to analyze the photos or video clips created or downloaded by its users, and then base on the detected attributes of the user's photos or video clips such as gender, age, appearance, attractiveness, emotions, ethnicity etc., select the most suitable scene clips from a scene clip database that best match the detected attributes, and then combine the user's photos or video clips with the selected scene clips in a proper way to create tailor-made combined videos for the users. Such combined videos are referred as APC Video (AI Powered Combined Video) in the present invention.

A typical APC Video comprises at least one master clip and at least one scene clip. A master clip is a photo or video clip (like a selfie photo or video) created by a master clip creator, the master clip creator also the person who receive the APC Video. A scene clip is a video clip created by a professional or skill content creator, the scene clip creator provides scene clips for combining with master clips. The master clips and scene clips can be combined in any meaningful ways to form an APC Video, as shown below.

APC Video 1=Master Clip+Scene Clip

APC Video 2=Scene Clip 1+Master Clip+Scene Clip 2

APC Video 3=Scene Clip 1+Master Clip 1+Scene Clip 2+Master Clip 2

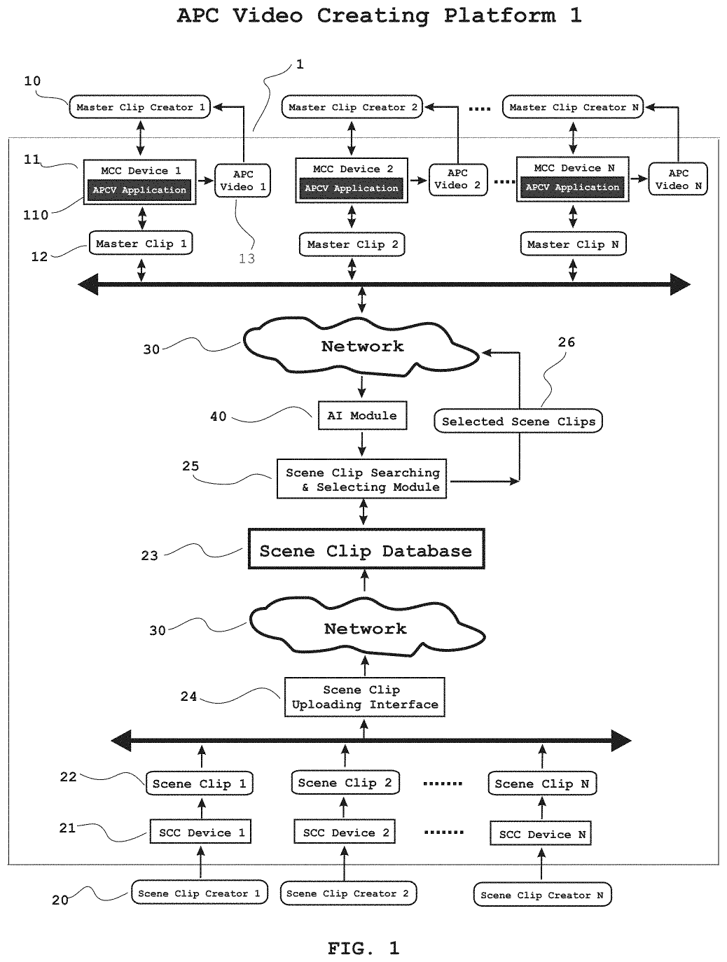

A typical embodiment of the present invention is illustrated in FIG. 1, the system of this embodiment is referred to as Platform 1. There are two types of user for Platform 1. One is Master Clip Creators 10 (average user) who creates Master Clips 12 to receive APC Videos 13, another one is Scene Clip Creators 20 (professional or skilled content creators) who creates Scene Clips 22 for combining with Master Clip 12 for the creation of APC Videos.

As illustrated in FIG. 1, Platform 1 is used by both Master Clip Creators 10 and Scene Clip Creator 20. Platform 1 comprises at least one MCC Device 11 (Master Clip Creating Device), an APCV Application 110, at least one SCC Device 21 (Scene Clip Creating Device), a Scene Clip Database 23, a Scene Clip Uploading Interface 24, a Scene Clip Searching & Selecting Module 25, a Network 30, and an AI Module 40.

MCC Device 11 and SCC Device 21 can be any type of digital device that is capable of creating or storing video contents, such as mobile phone, PC, tablet, etc., these devices can communicate with other components in Platform 1 via network 30. Network 30 is a wired or wireless internet that connects all the components in Platform 1.

Before an APC Video 13 can be created, at least one Scene Clip 22 must be stored in Scene Clip Database 23. To store a Scene Clip 22, Scene Clip Creator 20 first use SCC Device 21 to create or download a Scene Clip 22 according to a subject or script such as “Compliment for a women having attractiveness between 9-10, age between 18-30, emotion is happy”, etc, then connect SCC Device 21 to Scene Clip Uploading Interface 24, input at least one defined attributes of Scene Clip 22 such as subject, gender, age, attractiveness, emotions, ethnicity etc. to Scene Clip Uploading Interface 24, then press an uploading button, and Scene Clip 22 will be uploaded and stored in Scene Clip Database 23. The uploaded Scene Clip 22 is stored in Scene Clip Database 23 according to its defined attributes. For example, for a Scene Clip 22 of “Compliment for a woman having attractiveness betweens 9-10, age betweens 18-30, emotion is happy” its defined attributes can be as follows:

### Defined Attributes

Subject: Compliment

Gender: Female

Min. Age: 18

Max. Age: 30

Min. Attractiveness: 9

Max. Attractiveness: 10

Emotion: Happy

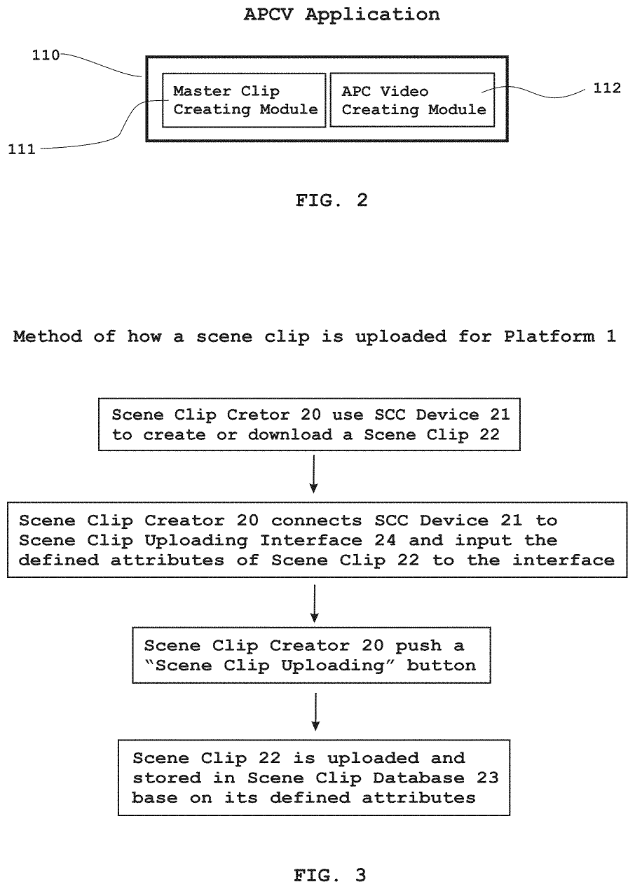

To create an APC Videos 13, a Master Clip Creator 10 first has to download an APCV Application 110 from an application hosting service such as Apple Store to his or her MCC Device 11. As illustrated in FIG. 2, APCV Application 110 has a Master Clip Creating Module 111 and an APC Video Creating Module 112.

As illustrated in FIG. 1, after APCV Application 110 is installed, Master Clip Creator 10 can use Master Clip Creating Module 111 to create or download at least one Master Clip 12, and then push a “Create APC Video” button, a copy of Master Clip 12 is sent to AI Module 40 for detecting its master clip attributes. For example, for a Master Clip 12 of “a smiling beautiful young woman”, its master clip attributes can be as follows:

### Master Clip Attributes

Gender: Female

Age: 23

Attractiveness: 9.3

Emotion: Happy

Base on the detected master clip attributes of Master Clip 12, Scene Clip Searching & Selecting Module 25 will search Scene Clip Database 23 and select at least one Scene Clip 26 with which its defined attributes match the detected master clip attributes, and then send a copy of Selected Scene Clips 26 back to APCV Application 110. After receiving Selected Scene Clip 26, APC Video Creating Module 112 combines Master Clip 12 with Selected Scene Clips 26 in a proper way to create an APC Video 13 for Master Clip Creator 10.

Such that Platform 1 comprising at least one MCC Device 11 that can be used by Master Clip Creator 10 to create or download Master Clip 12.

Such that Platform 1 has an APCV Application 110 that can be downloaded from an application hosting services to MCC Device 11. Application 110 has a Master Clip Creating Module 111 and an APC Video Creating Module 112. Master Clip Creating Module 111 has programs that enable Master Clip Creators 10 to create or download Master Clips 12 to MCC Device 11 and send copies of Master Clips 12 to AI Module 40 for analysis. APC Video Creating Module 112 has programs that are capable of combining Master Clips 12 with Selected Scene Clips 26 in a proper way to create APC Video 13.

Such that Platform 1 comprising at least one SCC Device 21 that can be used by Scene Clip Creator 20 to create or download Scene Clip 22 and upload Scene Clip 22 to Scene Clip Database 23.

Such that Platform 1 has a Scene Clip Database 3 that is capable of storing all uploaded Scene Clips 22, and allows all stored Scene Clips 22 to be searched and selected by Scene Clip Searching & Selecting Module 25.

Such that Platform 1 has a Scene Clip Uploading Interface 24 that enables Scene Clip Creators 20 to upload Scene Clip 22 to Scene Clip Database 23 base on its defined attributes.

Such that Platform 1 has an AI module 40 that has at least one artificial intelligence model that is capable of detecting the master clip attributes of a Master Clip 12.

Such that Platform 1 has a Scene Clip Searching & Selecting Module 25 that is capable of using the detected master clip attributes of a Master Clip 12 to search Scene Clip Database 23 to select at least one Scene Clips 26 with which its defined attributes match the master clip attributes of Master Clip 12.

Such that Scene Clip Searching & Selecting Module 25 has program that is capable of sending a copy of Selected Scene clips 26 to APC Video Creating Module 112 for creating an APC Video.

Such that APC Video Creating Module 112 has program that is capable of combing Master Clip 12 with Selected Scene Clip 26 in a proper way to create an APC Video 13.

### Operation of Preferred Embodiment

The operation of the present invention is very easy for both of Master Clip Creator 10 and Scene Clip Creator 20.

FIG. 3 illustrates the method of how a Scene Clip 22 is created and stored in Database 23 for Platform 1.

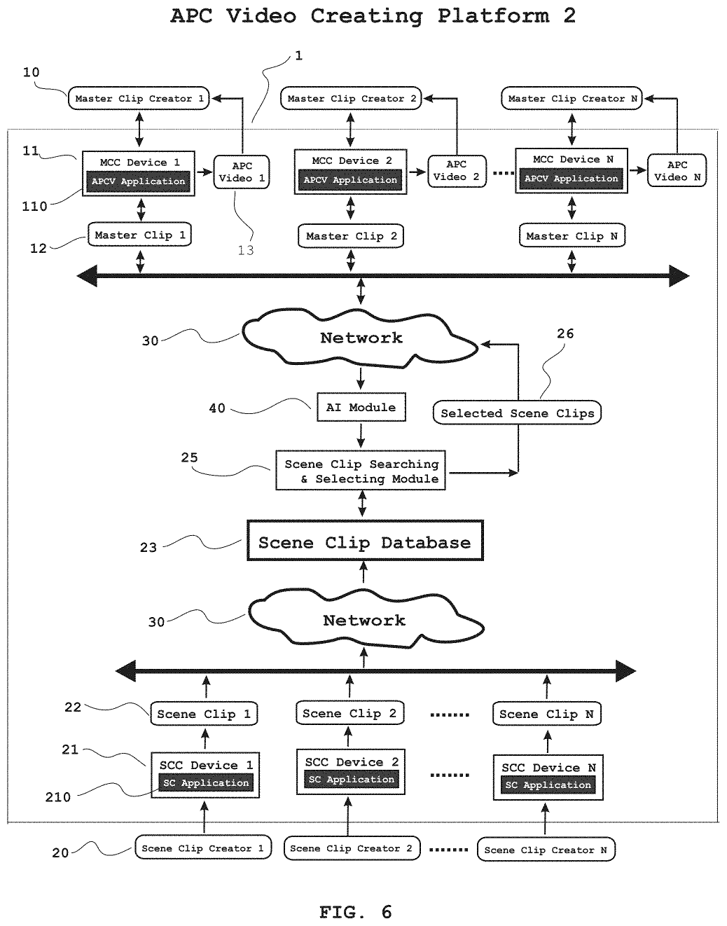

FIG. 7 illustrates the method of how a Scene Clip 22 is created and stored in Database 23 for Platform 2.

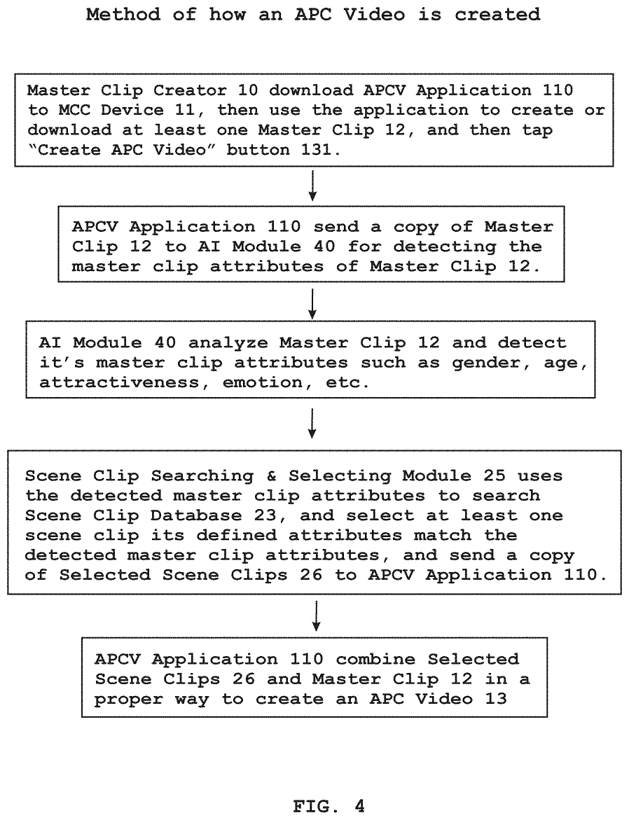

FIG. 4 illustrates the method of how an APC Video 13 is created. To create an APC Video 13, a Master Clip Creator 10 lust simply creates or downloads at least one Master Clip 12, then tap a “Create APC Video” button 131, and Platform 1 or Platform 2 will automatically create a tailor-made APC Video 13 for Master Clip Creator 10.

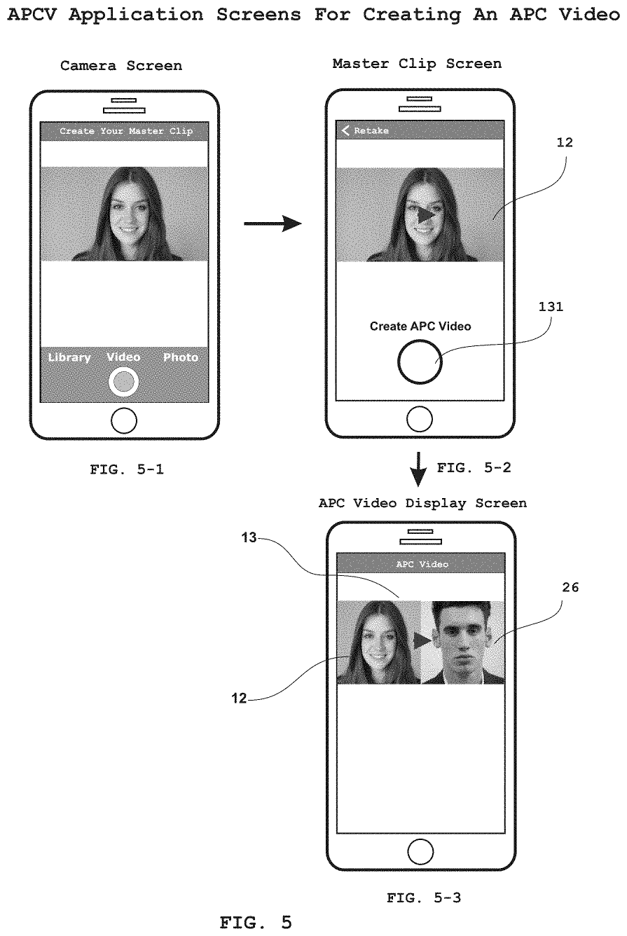

FIG. 5 illustrates the major screens of APCV application for creating an APC Video 13. FIG. 5-1 illustrates the “Camera Screen” of the application, in which a Master Clip Creator 10 can select to create or download a Master Clip 12 to the application. FIG. 5-2 illustrated the “Master Clip Screen”of the application, in which the created Master Clips 12 is displayed, Master Clip Creator 10 can review the Master Clip 12 and then simply tap a “Create APC Video” button 131 and a tailor-made APC Video 13 will be automatically created for Master Clip Creator 10. FIG. 5-3 illustrates the “APC Video Display Screen”, in which the finished APC Video 13 is displayed to Master Clip Creator 10.

Many different type of APC Video can be created by using the present invention. A typical APC Video 13 is a tailor-made compliment video. For example, a woman create a selfie video as Master Clip 12, AI Module 40 analyze the Master Clip 12 and detect that she is 20 years old and has an attractiveness rating of 9, then Scene Clip Searching & Selecting Module 25 will search Scene Clip Database 23 and select a Scene Clip 26 entitled “A man compliment a beautiful young woman for her beauty”, and atomically creates a tailor-made APC Video 13 showing a man compliment the woman for her beauty. Of course, different Scene Clips 26 can be selected to create different APC Videos for the woman.

### BRIEF DESCRIPTION OF ANOTHER EMBODIMENT

Another embodiment of the present invention is illustrated in FIG. 6, the system of this embodiment is referred to as Platform 2. Platform 2 is very similar to Platform 1 except the way of creating and uploading Scene Clip 22, in which Scene Clip Uploading Interface 24 is built into a SC Application 210 and installed in SCC Device 21.

As illustrated in FIG. 6, Platform 2 comprises at least one MCC Device 11, an APCV Application 110, at least one SCC Device 21, a SC Application 210, a Scene Clip Database 23, a Scene Clip Searching & Selecting Module 25, a Network 30, and an AI Module 40.

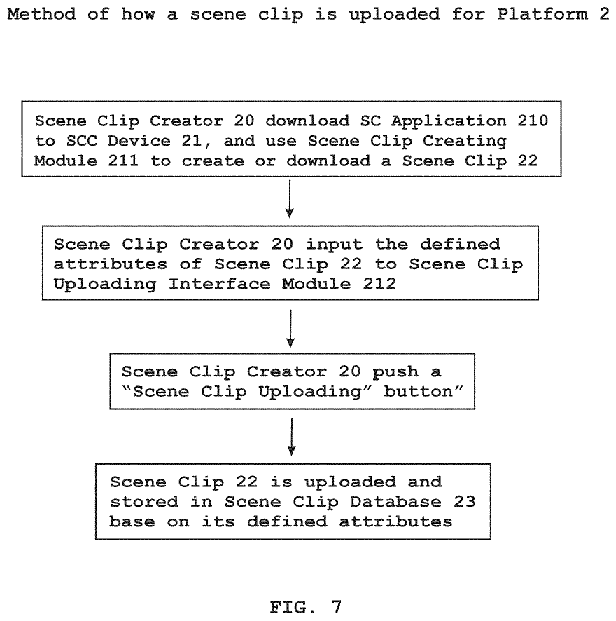

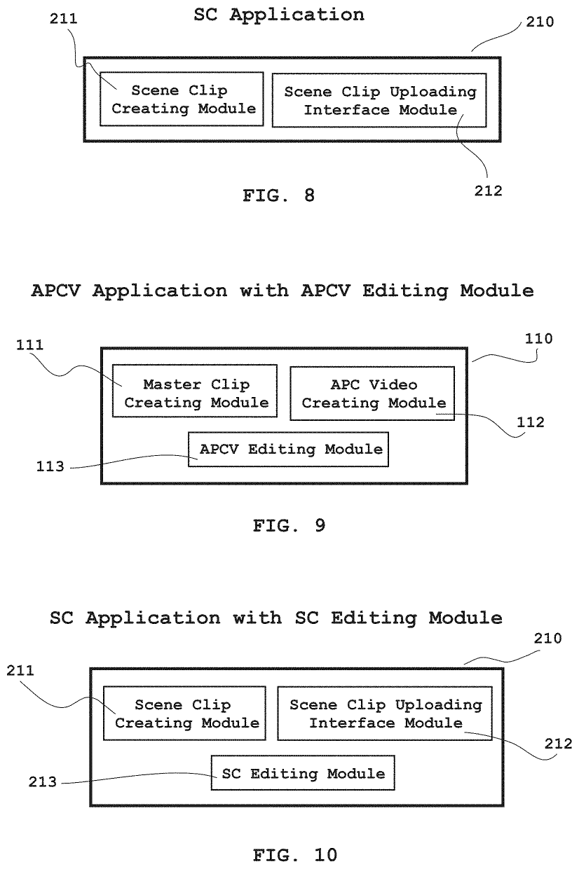

To store a Scene Clip 22, Scene Clip Creator 20 first download SC Application 210 from an application hosting service and install it to SCC Device 1. As illustrated in FIG. 8, SC Application 210 has a Scene Clip Creating Module 211 and a Scene Clip Uploading Interface Module 212. Scene Clip Creator 20 can use Scene Clip Creating Module 21 to create or download Scene Clip 22, then use Scene Clip Uploading Interface Module 212 to input the defined attributes of Scene Clip 22, then press an uploading button, and Scene Clip 22 will be uploaded and stored in Scene Clip Database 23. The uploaded Scene Clip 22 is stored in Scene Clip Database 23 according to its defined attributes.

Such that Platform 2 has a SC Application 210 that can be downloaded from an application hosting services to SCC Device 21. SC Application 210 has a Scene Clip Creating Module 211 and a Scene Clip Uploading Interface Module 212. Scene Clip Creating Module 211 has programs that enable Scene Clip Creators 20 to create or download Scene Clips 22 to SCC Device 21. Scene Clip Uploading Interface Module 212 has program that enables Scene Clip Creator 20 to upload Scene Clip 22 to Scene Clip Database 23 according to its defined attributes.

FIG. 7 illustrated the method of how a Scene Clip 22 is uploaded for Platform 2.

### Other Embodiments

As illustrated in FIG. 9, APCV Application 110 further having an APCV Editing Module 113 that is capable of editing Master Clip 12 and APC Video 13, such as trimming, making voice over, adding music, making special or after effects, changing background etc.

As illustrated in FIG. 10, SC Application 210 further having an SC Editing Module 213 that is capable of editing Scene Clip 22, such as trimming, making voice over, adding music, making special or after effects, changing background etc.

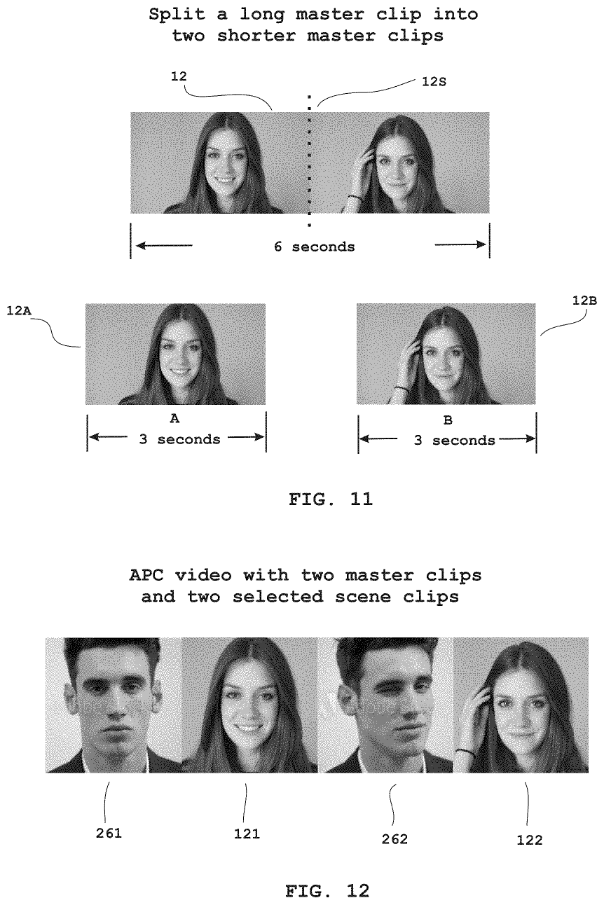

In order for Master Clip Creator 10 to create multiple Master Clips 12 easily, as illustrated in FIG. 11, APCV Editing Module 113 has program that is capable of splitting a long Master Clip 12 into at least two shorter Master Clips, such that Master Clip Creators 10 can have multiple short Master Clips by creating a long one. For example, a six second long Master Clip 12 can be split into a three second Master Clip 12A and a three second Master Clip 12B.

APCV Editing Module 113 has special program such as augmented reality (AR) that is capable of changing one Master Clip into another Master Clip.

Master Clip Creating Module 111 has program that enables Master Clip Creator 10 to create or upload multiple Master Clips 12 for the creation of one APC Video 13.

As illustrated in FIG. 12, APC Video Creating Module 112 has program that is capable of combining multiple Master Clips with multiple Scene Clips in a proper way for the creation of one APC Video 13.

AI Module 40 has speech recognition program that is capable of recognizing the speech content of Master Clips 12 to help Scene Clip Searching & Selecting Module 25 to select Scene Clips 26 more accurately.

AI Module 40 has speech generating program that is capable of generating speech that mimic the voice of a Master Clip Creator 10, and use the mimic speech as voice over in Master Clips 12 created by the Master Clip Creator 10.

APCV Application 110 has an interface that enables Master Clip Creators 10 to input their personal information such as birthday, anniversary, face image, voice sample, etc. to the system of present invention.

AI Module 40 has recognition program that is capable of recognize the voice, anniversary etc. of a Master Clip Creator 10, such that when this Master Clip Creator 10 creates a Master Clip 12 on the date of his or her anniversary, the program will recognize this information and automatically instruct APCV Application 110 to create a tailor-made anniversary APC Video 13 for Master Clip Creator 10.

AI Module 40 has a personal AI model that is capable of memorizing the past personal appearance of a Master Clip Creator 10 such as his or her past hairdo, dress, makeup, etc., such that when the Master Clip Creator 10 change his or her appearance, this personal AI model can detect the changes and automatically instruct APCV Application 110 to create an APC Video 13 to praise or make comment for the changes.

AI Module 40 has a predicting AI model that is capable of using the past behavior and created master clips of a Master Creator 10 to predict future master clip attributes of a future master clip created by Master Clip Creator 10, and use the predicted master clip attributes to preselect a certain number of scene clips and store these preselected scene clips in MCC Device 11, such that an APC video 13 can be created very quickly without any delay.

MCC Device 11 and SCC Device 21 is the same device, such that a user of the present invention can be a Master Clip Creator 10 as well as a Scene Clip Creator 20.

### SUMMARY, RAMIFICATION, AND SCOPE

According, the reader will see that the System and Method of AI-Powered Combined Video Production of the present invention is different from the conventional video combining technology, the present invention is a digital platform used by both of master clip creators and scene clip creators. In a preferred embodiment, the platform comprises at least one master clip creating device, an APCV application, at least one scene clip creating device, a scene clip database, a scene clip uploading interface, an module, and a scene clip searching & selecting module, and a network. The platform uses AI technology to detect the master clip attributes of a master clip, and then use the detected master clip attributes to search the scene clip database and select at least one scene clip its defined attributes match the detected master clip attributes, and then the APCV application will combine the master clip with the selected scene clip in a proper way to create an APC video. The present invention makes it extremely easy for average people to create high quality tailor-made combined videos.

Although the description above contains many specifications, these should not be construed as limiting the scope of the present invention but as merely providing illustrations of some of the presently preferred embodiments of this invention. Thus the scope of the present invention should be determined by the appended claims and their legal equivalents, rather than by the examples given.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A platform of AI-powered combined video production, said platform comprising:
(a) an AI-powered combined video application, said AI-powered combined video application is a software program that can be downloaded and installed to a smart phone by a smart phone user, said AI-powered combined video application further comprising:
(1) a master clip creating module, said master clip creating module is a software program that can be used by said smart phone user to create or upload master clips to said smart phone, once a master clip is created or uploaded in said smart phone, said master clip creating module is capable of automatically sending a copy of said master clip to an artificial intelligence model for detecting the attributes of said master clip.
(2) an AI-powered combined video creating module, said AI-powered combined video creating module is a software program that is capable of automatically receiving a copy of selected scene clip from a scene clip database and combine said selected scene clip with said master clip to create a combined video.
(b) a scene clip database, said scene clip database is capable of storing scene clips uploaded to said scene clip database, said scene clip database store at least one scene clip, said scene clip is stored in said scene clip database base on the defined attributes of said scene clip, said scene clip can be searched and selected by a scene clip searching & selecting module base on said defined scene clip attributes.
(c) an AI module, said AI module has at least one artificial intelligence model that is capable of receiving a copy of said master clip and automatically detecting the attributes of said master clip once said master clip is created or uploaded to said smart phone.
(d) a scene clip searching & selecting module, said scene clip searching & selecting module is a software program that once said master clip attributes are detected, is capable of automatically using said detected master clip attributes to search said scene clip database to select a scene clip its defined attributes match said master clip attributes, said scene clip search & selecting module is capable of automatically sending a copy of said selected scene clip to said AI-powered combined video creating module for creating a combined video.
wherein said smart phone is connect to a network by said smart phone user to install said AI-powered combined video application to said smart phone.
wherein said master clip creating module is used by said smart phone user to create or upload a master clip to said smart phone.
wherein once said master clip is created or uploaded to said smart phone, a copy of said master clip is automatically sent to said AI module by said AI-powered combined video application for detecting the attributes of said master clip.
wherein once the attributes of said master clip are detected by said AI module, said detected master clip attributes are automatically used by said scene clip searching & selecting module to search said scene clip database to select a scene clip its defined attributes match said detected master clip attributes.
wherein a copy of said selected scene clip is automatically sent to said AI-powered combined video creating module by said scene clip searching & selecting module.
